(19) United States
(12) Patent Application Publication
(10) Pub. No.: US 2010/0039517 A1
(43) Pub. Date: Feb. 18, 2010

(54) FILM CADENCE DETECTION

(75) Inventors: Dmitry Znamenskiy, Eindhoven (NL); Claus Nico Cordes, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/521,780

(22) PCT Filed: Dec. 21, 2007
(86) PCT No.: PCT/IB2007/055278

§ 371 Date: Jun. 30, 2009

(30) Foreign Application Priority Data
Jan. 3, 2007 (EP) 07300699.1

(51) Int. Cl. H04N 17/00

(52) U.S. Cl. 348/180; 348/E17.001

(57) ABSTRACT

A film cadence in a video signal (VA) is detected in the following manner Successive classification indications (BC_{N}, BC_{N-1}, BC_{N-2}, •••) are generated for successive images within the video signal. A classification indication belongs to a particular image and indicates whether that particular image is an original image or a repeat image. A condition is checked for at least X successive classification indications, X representing a natural number in a given range. The condition is that each one of the at least X successive classification indications is equal to the X-th previous classification indication. If the condition is true, a pattern indication (PI) is provided, which corresponds with the natural number that X represents. If the condition is false, the condition is checked anew with X representing another natural number in the given range.

### FIELD OF THE INVENTION

An aspect of the invention relates to a method of film cadence detection for detecting a particular pull-down pattern that may be present in a video signal. Other aspects of the invention relate to a film cadence detector, a video system, and a computer program product for a programmable processor.

### BACKGROUND ART

A video signal typically has a format that provides for 50 or 60 images per second. An image may be a field or a frame depending on whether the format provides for interlaced scanning or progressive scanning, respectively. In contrast, a motion picture, which is another word for a movie, typically has a format that provides for 24 or 25 images per second. Moreover, the images are typically recorded on a film by means of a photographic process.

A process known as telecine is generally used to transform a motion picture into a video signal. The telecine process involves an image rate conversion. In many cases, an image of an original motion picture is repeated one or more times in order to achieve a higher image rate. A video signal that has been obtained by applying a telecine process to a motion picture therefore comprises original images and repeat images. Such a video signal will be referred to as telecine video signal hereinafter.

An image repetition in a telecine video signal follows a given pattern, which is in conformity with the image rate conversion that is required. For example, let it be assumed that the motion picture has a rate of 24 images per second. Let it further be assumed that the video signal has a rate of 60 images per second. In that case, a 24-to-60 image rate conversion is required. This can be achieved by repeating odd-numbered images in the motion picture twice and by repeating even-numbered images once, or vice versa. There is a 3:2 pattern, which provides an image rate increase by a factor of 2.5. Such a repeat pattern is often referred to as pull-down pattern or film cadence.

A video signal that comprises a slow-motion sequence may also exhibit a pull-down pattern. For example, a broadcast of a sports event typically comprises one or more slow-motion sequences. So-called slow motion controllers typically generate a slow-motion sequence by repeating originally captured images one or more times. A pull-down pattern in a slow-motion sequence may be relatively exotic. For example, a pull-down pattern of 2:3:2:2:2:3:2:1:3 was found in a video signal from a sports channel. It should further be noted that there are video effects other than slow-motion, which may introduce a particular pull-down pattern.

There are various types of video signal processing in which it is advantageous to distinguish between original images and repeat images. A suboptimal result would be obtained if such a type of video signal processing was to process a telecine video signal in a fashion that is based on an assumption that each image is unique, which is not the case in the telecine video signal. Examples of types of video signal processing, which should preferably distinguish between original images and repeat images, include: image rate conversion, which is often called frame rate conversion, de-interlacing and pull-down optimization.

A film cadence detector can provide a pattern indication that allows a video signal processor to distinguish between original images and repeat images. A film cadence detector detects that a given video input signal, or a portion thereof, results from a telecine process. That is, a film cadence detector detects that the video input signal is a telecine video signal. In addition, the film cadence detector typically detects a particular pull-down pattern, which is also called film cadence, in the telecine video signal. The pull-down pattern indicates whether a particular image in the telecine video signal is an original image or a repeat image.

A film cadence detector typically comprises a state machine whose states are associated with a number of fixed pull-down patterns. Transitions between states are determined by detected differences between successive images. The greater the number of different pull-down patterns that the state machine can handle, the more complex the state machine is. Moreover, such a film cadence detector is not very flexible in the sense that the film cadence detector can only detect a limited repertoire of pull-down patterns. The film cadence detector fails to give a proper indication in case an input video signal comprises a pull-down pattern that is not included in this limited repertoire.

The international patent application published under number WO 01/013647 discloses an apparatus for detecting telecine mode in a sequence of video fields. A first video field and a second video field are compared to determine if one of the first and second fields is a repeat field. A telecine mode is declared if a sequence of repeat fields corresponds to a telecine pattern. The apparatus comprises various state machines whose respective state diagrams are illustrated in FIGS. 10-13 of this international patent application.

### SUMMARY OF THE INVENTION

It is an object of the invention to provide a film cadence detector that can handle a relatively great variety of pull-down patterns at moderate cost. The independent claims define various aspects of the invention. The dependent claims define additional features for implementing the invention to advantage.

In accordance with the invention, a film cadence in a video signal is detected in the following manner. Successive classification indications are generated for successive images within the video signal. A classification indication belongs to a particular image and indicates whether that particular image has been classified as an original image or a repeat image. A condition is checked for at least X successive classification indications, X representing a natural number in a given range. The condition is that each one of the at least X successive classification indications is equal to the X-th previous classification indication. If the condition is true, a pattern indication is provided, which corresponds with the natural number that X represents. If the condition is false, the condition is checked anew with X representing another natural number in the given range.

Film cadence detection in accordance with the invention can be implemented with relatively simple hardware or software, or combination of both. There is no need for any complicated state machine. Moreover, the film cadence detection is universal in the sense that a relatively great variety of pull-down patterns can be detected.

An implementation of the invention advantageously comprises one or more of following additional features, which are described in separate paragraphs that correspond with individual dependent claims.

The aforementioned condition is preferably first checked with X representing the highest natural number in the range and whereby, if the condition is false, the condition is checked anew with X representing a next highest natural number.

Film cadence detection in accordance with the invention preferably involves a counter register comprising respective counter values. A counter value is associated with a particular natural number that X may represent. The following steps are executed when a new classification indication is generated. For each natural number that X may represent, it is checked whether the new classification indication is equal to the X-th previous classification indication. If so, the counter value that is associated with the natural number that X represents, is incremented. If not, the counter value is reset. It is further checked whether a counter value is at least equal to the natural number with which the counter value is associated. If so, a pattern indication is provided that corresponds with this natural number.

A difference metric for an image is preferably calculated in the following manner. A local difference is determined for various pixels in the image. Each of these pixels has a particular value and a particular position within the image. The local difference for a pixel is determined as follows. A set of neighboring pixels in a neighboring image is defined. The neighboring pixels have respective positions within the neighboring image, which are similar to the position of the pixel in the image of interest. A minimum pixel value and a maximum pixel value within the set of neighboring pixels are determined. The local difference has a first given value or a second given value depending on whether the value of the pixel is within a range that depends on the minimum pixel value and the maximum pixel value or outside this range, respectively. A sum of the respective local differences for the respective pixels is calculated. The sum represents the difference metric for the image. It is decided on the basis of the difference metric, whether the current image classifies as an original image or a repeat image.

A current image is preferably classified as an original image or a repeat image on the basis of at least a difference metric for the current image and the aforementioned pattern indication.

Such a classification is preferably done in the following manner. An expected classification indication is determined for the current image on the basis of the pattern indication. A most probable sequence of classification indications is determined on the basis of several difference metrics. It is verified whether the most probable sequence of classification indications is in conformity with the expected classification indication, or not. The classification indication for the current image is made equal to the expected classification indication if the verification step is positive. Conversely, the classification indication is made unequal to the expected classification indication if the verification step is negative.

The additional features identified in the preceding paragraphs contribute to reliability and cost-efficiency.

A detailed description with reference to drawings illustrates the invention summarized hereinbefore, as well as the additional features.

### BRIEF DESCRIPTION OF THE DRAWINGS

FIG. 1 is a block diagram that illustrates a video system.

FIG. 2 is a conceptual diagram that illustrates a frame rate conversion of a video that has a 3:2 pull-down pattern.

FIG. 3 is a functional diagram that illustrates a film cadence detector, which forms part of the video system.

FIG. 4 is a flow chart diagram that illustrates a series of steps for detecting a cadence pattern on the basis of a classification bit stream.

FIGS. 5A-5K are tables that illustrate a detection of a cadence pattern.

FIGS. 6A and 6B are flow chart diagrams that illustrate a series of steps for calculating a difference metric on the basis of a current image and a previous image.

FIG. 7 is a flow chart diagram that illustrates a series of steps for generating a classification bit on the basis of at least one difference metric.

FIG. 8 is a block diagram that illustrates a processor that constitutes a software-based implementation of the film cadence detector.

### DETAILED DESCRIPTION

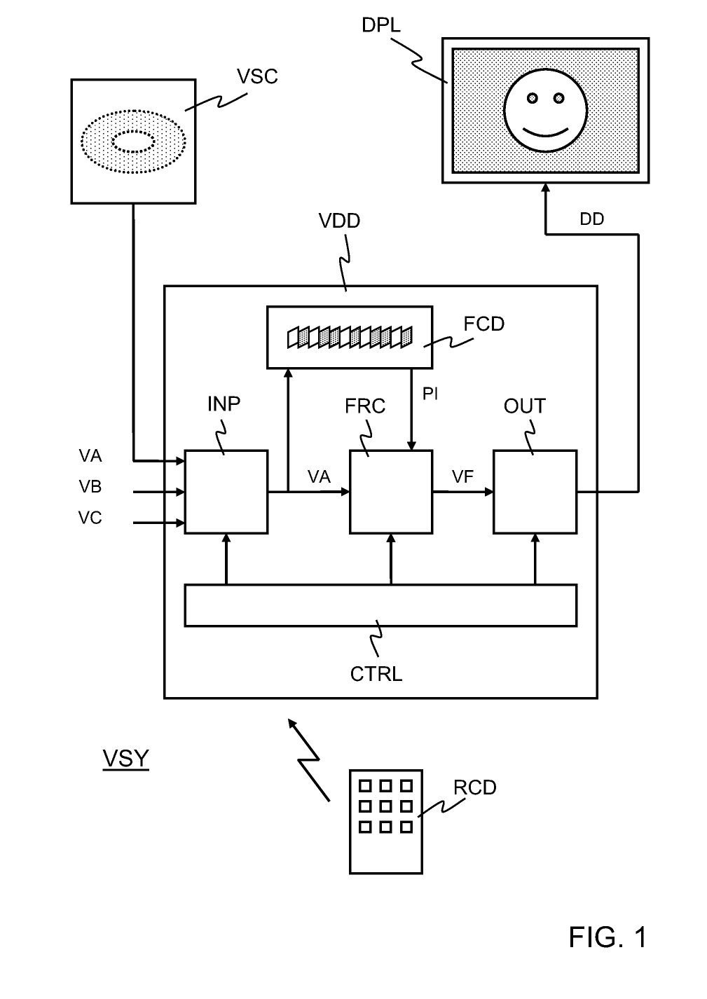

FIG. 1 illustrates a video system VSY. The video system VSY comprises a video source VSC, a video display driver VDD, a display device DPL, and a remote control device RCD. In more detail, the video display driver VDD comprises an input circuit INP, a film cadence detector FCD, a frame rate converter FRC, an output circuit OUT, and a controller CTRL. The video source VSC may be, for example, a video recorder, a video broadcast receiver, or a communication network interface for downloading a video from server. The display device DPL may be, for example, a flat panel display of the liquid crystal type.

The video display driver VDD basically operates as follows. The video display driver VDD receives a video input signal VA from the video source VSC. The video display driver VDD may receive other video input signals VB, VC from other video sources. A user may select one of the video input signals VA, VB, VC by means of his or her remote control device RCD. It is assumed that the user has selected the video input signal VA from the video source VSC. Consequently, the frame rate converter FRC receives this video input signal VA. It will be assumed hereinafter, by way of example, that the video input signal VA has a frame rate of 60 frames per second.

The video input signal VA may comprise film material: a sequence of frames that originate from a motion picture, which is another word for a movie. Motion pictures are generally provided in a format of 24 frames per second. The video input signal VA has a different format of 60 frames per second. A process known as “telecine” has been used to convert the motion picture from the format of 24 frames per second to the format of 60 frames per second. This 24-to-60 frame rate conversion typically involves a so-called 3:2 pull-down pattern: odd-numbered frames are repeated twice and even-numbered frames are repeated once, or vice versa. Telecine may involve other pull-down patterns depending on the frame rate conversion of interest. Some examples of other telecine pull-down patterns are: 2:2, 2:3:3:2, and 2:2:2:4.

The video signal VA may equally comprise a slow-motion sequence, which exhibits a particular a pull-down pattern. For example, a broadcast of a sports event typically comprises one or more slow-motion sequences, which may have been generated by repeating originally captured images one or more times. A slow-motion pull-down pattern may be relatively exotic, such as, for example: 2:3:2:2:2:3:2:1:3. There are video effects other than slow-motion, which may introduce a particular pull-down pattern. Some examples of other pull-down patterns are: 3:2:3:2:2, 5:5, 6:4, and 8:7.

Let it be assumed that the video input signal VA comprises film material. This means that the video input signal VA has a particular pull-down pattern, which results from a telecine operation. The film cadence detector FCD detects the pull-down pattern. The film cadence detector FCD provides a pattern indication PI, which is a description of the pull-down pattern that has been detected. The film cadence detector FCD will be described in greater detail hereinafter.

The frame rate converter FRC subjects the video input signal VA to a frame rate conversion. For example, the frame rate converter FRC may double the frame rate in order to enhance perceived image quality. Since it was assumed that the frame rate of the video input signal VA is 60 frames per second, the frame rate converter FRC will then provide a video display signal VD with a frame rate of 120 frames per second. The video display signal VD corresponds with the video input signal VA in terms of content, but has a different frame rate.

The output circuit OUT illustrated in FIG. 1 provides a display driver signal DD in response to the video display signal VD, which the frame rate converter FRC provides. To that end, the output circuit OUT may carry out various signal processing operations, such as, for example, amplification, level shifting, bias voltage generation, and synchronization. The display device DPL, which receives the display driver signal DD, thus displays an enhanced version of the video input signal VA.

The frame rate converter FRC carries out the frame rate conversion on the basis of the pattern indication PI, which the film cadence detector FCD provides. The pattern indication PI tells the frame rate converter FRC, as it were, which frames in the video input signal VA are repeat frames and which frames are original frames, with a relatively high degree of reliability. The frame rate converter FRC can use this information to advantage for optimizing the frame rate conversion in terms of perceived image quality. For example, let it be assumed that the frame rate conversion involves making interpolations between successive images. An interpolation between an original frame and a repeat of that original frame should preferably be avoided. The pattern indication PI can avoid such an interpolation so as to ensure each interpolation concerns two original frames or their respective copies.

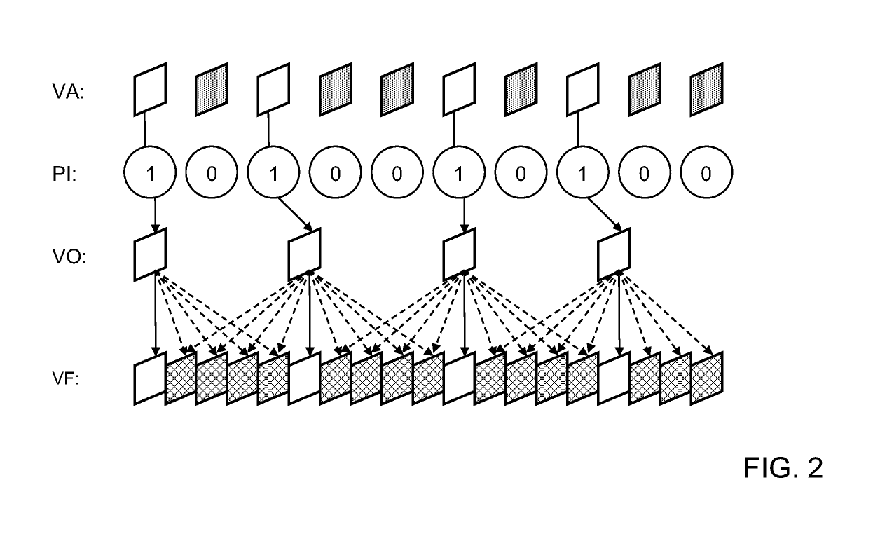

FIG. 2 illustrates an example of a frame rate conversion. FIG. 2 is a conceptual diagram with four layers. An upper layer represents the video input signal VA, an upper-middle layer represents the pattern indication PI, a lower-middle layer represents an original motion picture VO, and a lower layer represents the video display signal VD. In FIG. 2, parallelograms represent frames. This applies to the video input signal VA, the original motion picture VO, and the video display signal VD. FIG. 2 has a horizontal axis, which represents time.

The video input signal VA has a 3:2 pull-down pattern. In the upper layer, a parallelogram with no filling represents original frames. A parallelogram with a grayish filling represents a repeat frame. The pattern indication PI comprises a sequence of bits, which are represented as circles. There is a specific bit for each frame in the video input signal VA. In case the frame classifies as an original frame, the bit is equal to 1. Conversely, in case the frame classifies as a repeat frame, the bit is equal to 0.

The pattern indication PI allows the frame rate converter FRC to reconstruct the original motion picture VO. To that end, the frame rate converter FRC ignores the repeat frames and retains the original frames only. In FIG. 2, there are 2 original frames within each sequence of 5 frames in the video input signal VA. The frame rate converter FRC effectively repositions at least one of these 2 original frames on the horizontal axis, which corresponds with introducing a time shift. This repositioning is done in order to equidistantly position the original frames from the video input signal VA on the horizontal axis. Accordingly, the original motion picture VO is obtained.

The frame rate converter FRC generates a set of intermediate frames between two successive original frames. In the lower layer, parallelograms with a cross-hatched filling represent intermediate frames. The intermediate frames, which are included in the video display signal VD, provide a relatively high frame rate. The frame rate converter FRC may generate the intermediate frames by means of interpolations between two successive original frames. Different interpolations may be used for different intermediate frames within a set. For example, an interpolation that is used for generating a particular intermediate frame, which has a particular temporal position between two successive original frames, may depend on this particular temporal position. The interpolation may involve, for example, motion compensation. Alternatively, the interpolation may be a linear blending between the two successive original frames, wherein the one and the other original frame have respective weights that depend on the particular temporal position of the intermediate frame of interest.

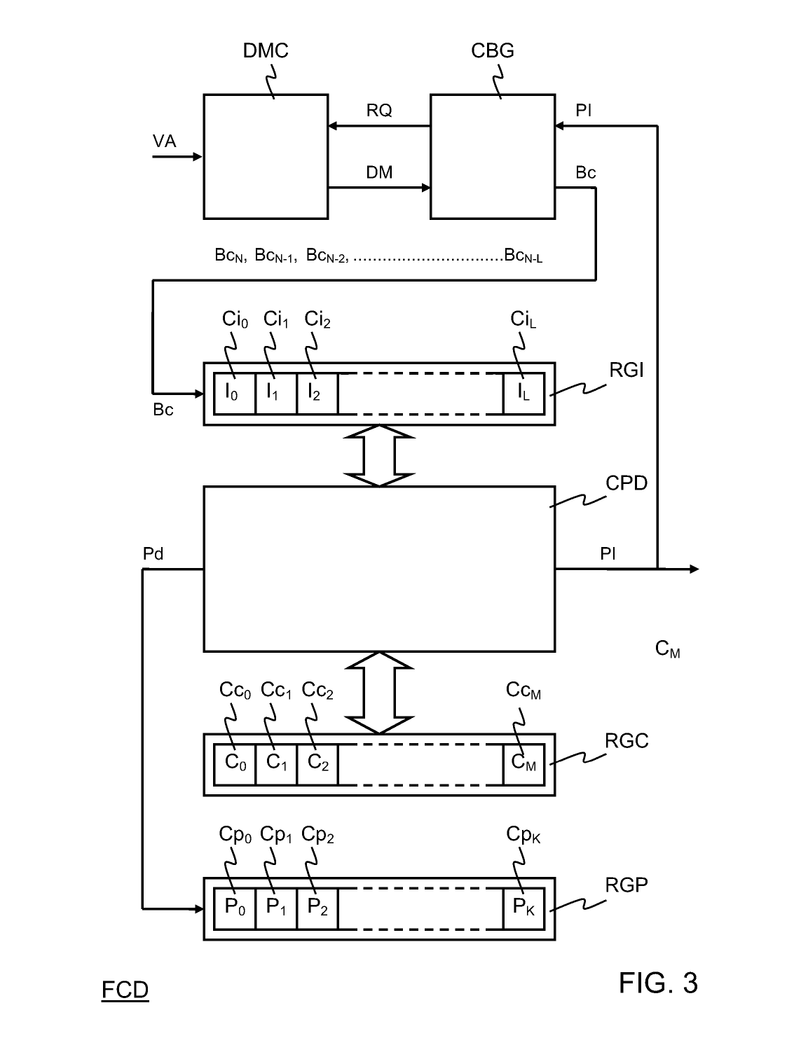

FIG. 3 illustrates the film cadence detector FCD, which provides the pattern indication PI that plays an important role in the frame rate conversion. The film cadence detector FCD comprises the following functional entities: a difference metric calculator DMC, a classification bit generator CBG, an input value register RGI, a cadence pattern detector CPD, a counter value register RGC, and a detected period register RGP. The input value register RGI comprises an array of cells Ciₒ, Ci₁, Ci₂, . . . , Ci_{L} for storing an array of input values I₀, I₁, I₂, . . . , I_{L}, respectively. The input value register RGI has a total of L+1 cells, L being a natural number. The counter value register RGC comprises an array of cells Cc₀, Cc₁, Cc₂, . . . , Cc_{M} for storing an array of cells of counter values C₀, C₁, C₂, . . . , C_{M}, respectively. The counter value register RGC has a total of M+1 cells, M being a natural number, which is preferably smaller than L or equal thereto. The detected period register RGP comprises an array of cells Cp₀, Cp₁, Cp₂, . . . , CP_{K} for storing an array of detected periods P₀, P₁, P₂, . . . , P_{K}, respectively. The counter value register RGC has a total of K+1 cells, K being a natural number.

The film cadence detector FCD basically operates as follows. The difference metric calculator DMC calculates a difference metric DM for each frame in the video input signal VA. The difference metric DM is a value that indicates an amount of difference between the frame of interest and a previous frame. Accordingly, the difference metric DM expresses a degree of likelihood that the frame of interest is an original frame or, conversely, a degree of likelihood that the frame of interest is a repeat frame.

The classification bit generator CBG receives successive difference metrics that belong to successive frames in the video input signal VA. The classification bit generator CBG classifies each frame in the video input signal VA as an original frame or a repeat frame on the basis of the difference metric DM for that frame and, if needed, further difference metrics. Moreover, the classification bit generator CBG utilizes the pattern indication PI in carrying out this classification. The pattern indication PI provides a basis that allows the classification bit generator CBG to predict whether a current frame should classify as an original frame or a repeat frame. This utilization of the pattern indication PI effectively constitutes a feedback in a classification process, in which previous classifications play a role in making new classifications. It should further be noted that the classification bit generator CBG may issue a request RQ to the difference metric calculator DMC for calculating further difference metrics.

The classification bit generator CBG provides a classification bit Bc for each frame in the video input signal VA in a corresponding order. The classification bit Bc has a value that is equal to 1 if the frame of interest classifies as an original frame. Conversely, the value of the classification bit Bc is equal to 0 if the frame of interest classifies as a repeat frame. Accordingly, the classification bit generator CBG provides successive classification bits BC_{N}, BC_{N-1}, BC_{N-2}, . . . , BC_{N-L}, . . . that belong to successive frames in the video input signal VA. The successive classification bits BC_{N}, BC_{N-1}, BC_{N-2}, . . . , BC_{N-L}, . . . illustrated in FIG. 3 have reference signs that comprise an index. The index represents a frame number, which distinguishes individual frames in the video input signal VA from each other. Accordingly, each individual classification bit Bc has a different frame number. N is a natural number that represents the frame number of the most recent classification bit BC_{N} that the classification bit generator CBG has produced.

The input value register RGI receives the successive classification bits BC_{N}, BC_{N-1}, BC_{N-2}, . . . , BC_{N-L}, . . . that the classification bit generator CBG has provided. The input value register RGI operates on a first-in first-out basis. Accordingly, the input value register RGI stores the L most recent classification bits that the classification bit generator CBG has provided. The most recent classification bit Bc_{N} is present in cell Ci₀ and therefore constitutes input value I₀. The one-but-most recent classification bit BC_{N-1} is present in cell Ci₁ and therefore constitutes input value I_{I}, and so on.

The respective classification bits that are stored in the input value register RGI shift one cell position when the classification bit generator CBG produces a new classification bit Bc. Initially, the input value register RGI will be empty. A first classification bit is stored into cell Ci₀ and constitutes input value I₀. This first classification bit moves to cell Ci₁ and constitutes input value I₁, when a second classification bit arrives. This process continues so that each cell comprises a classification bit once the classification bit generator CBG has produced more than L classification bits. A steady state situation is achieved.

The cadence pattern detector CPD updates respective counter values C₀, C₁, C₂, . . . , C_{M} in the counter value register RGC each time a new classification bit Bc has been stored in the input value register RGI. That is, the counter value register RGC is updated on a frame by frame basis. Each counter value is associated with a possible periodicity that may be present within the classification bits that have been stored in the input value register RGI. Counter value C₁ is associated with a period of 1 frame. Counter value C₂ is associated with a period of 2 frames, and so on. Counter value C_{M} is associated with a period of M frames, which is a maximum period that can be detected. Initially, each counter value is set to 0.

The cadence pattern detector CPD updates the counter value register RGC on the basis of the input values that are stored in the input value register RGI. In doing so, the cadence pattern detector CPD may detect a periodicity within the input values that are stored in the input value register RGI. The cadence pattern detector CPD provides a detected period Pd when there is such a periodicity. The detected period Pd is a natural number greater than 0 and smaller than M, which is the maximum period that can be detected.

The cadence pattern detector CPD writes the detected period Pd into cell Cp₀ of the detected period register RGP, which operates on a first-in first-out basis. Accordingly, each previously detected period Pd, if any, that is present in this register moves one cell position. The detected period register RGP thus comprises a history of detected periods. The cadence pattern detector CPD establishes the pattern indication PI on the basis of the detected periods that are stored in the detected period register RGP and the input values that are stored in the input value register RGI.

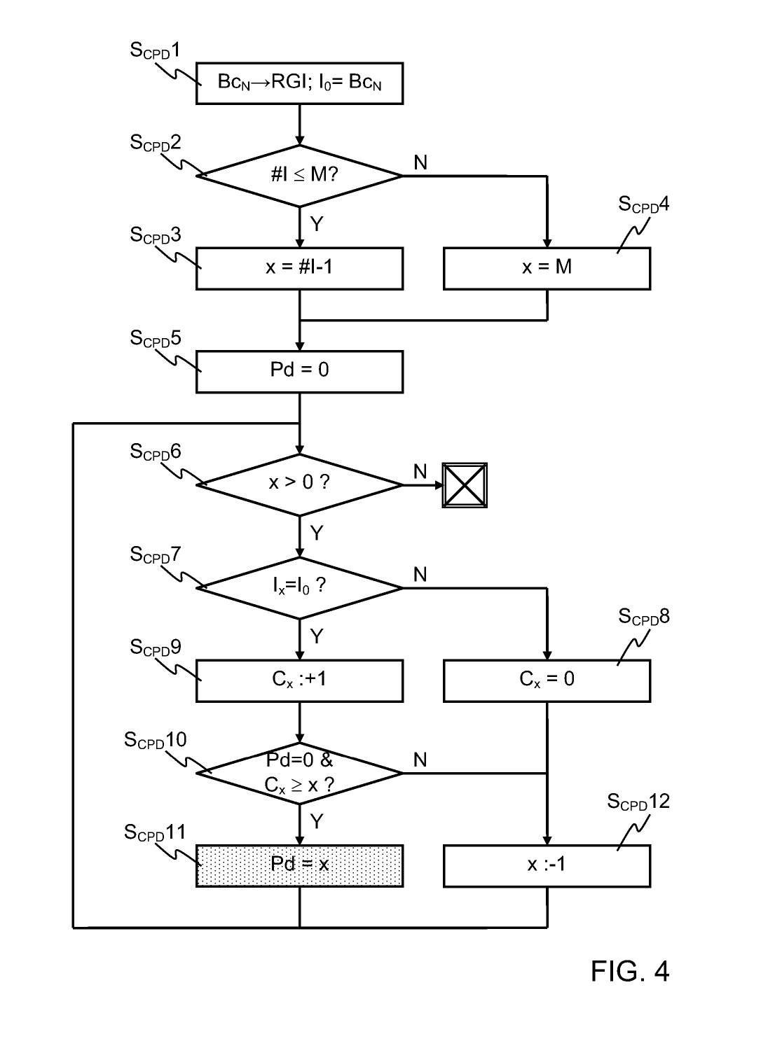

FIG. 4 illustrates a series of steps S_{CPD}1-S_{CPD}12 that the cadence pattern detector CPD carries out in order to detect a periodicity within the input values that are stored in the input value register RGI. The cadence pattern detector CPD carries out these steps for each new classification bit Bc that the classification bit generator CBG provides. It is assumed that classification bit BC_{N} illustrated in FIG. 3 is such a new classification bit. The other classification bits have been previously generated.

In step S_{CPD}1, the new classification bit BC_{N} is written into the input value register RGI (Bc_{N}→RGI). Accordingly, the new classification bit Bc_{N} constitutes input value I₀, which is stored in cell Ci₀ of the input value register RGI (I₀=Bc_{N}). As explained hereinbefore, assuming that a classification bit was previously stored in cell, this classification bit moves to cell Ci₁. Similarly, any further classification bits that were already present in the input value register RGI each move each one cell position. At the end of step S_{CPD}1, a given number of input values will be present in the input value register RGI. In the steady state situation, L+1 input values are present in the input value register RGI. There may be a smaller number of input values during an initial phase.

In step S_{CPD}2, the cadence pattern detector CPD checks whether the following condition is true or not: the number of input values that are present in the input value register RGI is smaller than M or equal thereto (#I≦M?). In case the aforementioned condition is true, the maximum period M cannot be detected yet because there is insufficient number of input values. This will typically be the case during the initial phase. In case the aforementioned condition is not true, there are sufficient input values to detect the maximum period M. This will typically be the case in the steady state condition. The cadence pattern detector CPD carries out step S_{CPD}3 or step S_{CPD}4 depending on whether the aforementioned condition is true or not, respectively.

In step S_{CPD}3, or step S_{CPD}4, the cadence pattern detector CPD assigns an initial value to a cell index parameter x. The cell index parameter x is a natural number that designates a particular cell Ciₓ in the input value register RGI, as well as the input value Iₓ that is stored in that particular cell. In addition, the cell index parameter x designates a particular cell Ccₓ in the counter value register RGC, as well as the counter value Cₓ that is stored in that particular cell. For example, let it be assumed that the cell index parameter x has a value that is equal to 2. In that case, the cell index parameter x designates the input value I₂ and the counter value C₂, which are present in cell Ci₂ and cell Cc₂, respectively. The cell index parameter x can also be regarded as a pointer that points to a particular cell and the value comprised in that cell.

In step S_{CPD}3, the cadence pattern detector CPD sets the initial value of the cell index parameter x so that this value is equal to the number of input values #I that are present in the input value register RGI minus one (x=#I−1). Accordingly, the cell index parameter x initially points to the oldest input value that is present in the input value register RGI. In the initial phase, this oldest input value is the first classification bit that the classification bit generator CBG has provided following a startup.

In step S_{CPD}4, the cadence pattern detector CPD sets the initial value of the cell index parameter x so that this value is equal to the maximum period M that can be detected (x=M). Accordingly, the cell index parameter x initially points to the input value I_{M}.

In step S_{CPD}5, the cadence pattern detector CPD sets the detected period Pd to 0 (Pd=0). The detected period Pd being equal to 0, signifies that no period has been detected yet. Any other value signifies that a period has been detected.

In step S_{CPD}6, the cadence pattern detector CPD verifies whether the following condition is true or not: the cell index parameter x is greater than 0 (x>0 ?). In case the aforementioned condition is true, the cadence pattern detector CPD carries out steps S_{CPD}7 and subsequent steps, which will be discussed in greater detail hereinafter. In case the aforementioned condition is not true, the cadence pattern detector CPD stops carrying out the steps illustrated in FIG. 4. The cadence pattern detector CPD will carry out these steps anew when a subsequent classification bit has been written into the input value register RGI.

In step S_{CPD}7, the cadence pattern detector CPD verifies whether the following condition is true or not: the input value Iₓ to which the cell index parameter x points is equal to the input value I₀, which is the most recent classification bit BC_{N} (Iₓ=I₀?). In case the aforementioned condition is true, the input values, which are present in the input value register RGI, may potentially have a periodicity that is equal to the cell index parameter x, which is a natural number. In that case, the cadence pattern detector CPD carries out steps S_{CPD}9 and S_{CPD}10, which will be discussed in greater detail hereinafter. In case the aforementioned condition is not true, the input values, which are present in the input value register RGI, do not potentially have a periodicity that is equal to the cell index parameter x. In that case, the cadence pattern detector CPD carries out step S_{CPD}8.

In step S_{CPD}8, the cadence pattern detector CPD resets the counter value Cₓ to which the cell index parameter x points (Cₓ=0). That is, this counter value Cₓ is made equal to 0. As explained hereinbefore, the counter value Cₓ to which the cell index parameter x points is associated with a possible periodicity that corresponds with the cell index parameter x in terms of number of frames. Resetting this counter value Cₓ can be regarded as an assessment that the successive classification bits from the classification bit generator CBG do probably not have a periodicity that is equal to the cell index parameter x. There has been a negative test, as it were, for the periodicity concerned. The cadence pattern detector CPD will then subsequently carry out step S_{CPD}9, which will be discussed hereinafter.

Conversely, in step S_{CPD}9, the cadence pattern detector CPD increments by one unit the counter value Cₓ to which the cell index parameter x points (Cₓ:+1). That is, one unit is added to this counter value Cₓ, which becomes the new counter value for the cell Ccₓ to which the cell index parameter x points. Incrementing this counter value Cₓ can be regarded as an assessment that the successive classification bits are likely to have a periodicity that is equal to the cell index parameter x. There has been a positive test, as it were, for the periodicity concerned.

In step S_{CPD}10, which succeeds step S_{CPD}9, the cadence pattern detector CPD verifies whether the following two conditions are true or not. Firstly, is the detected period equal to 0 (Pd=0)? Secondly, is the counter value Cₓ to which the cell index parameter x points, equal to or larger than the cell index parameter x, which is a natural number (Cₓ≧x)? In case the first condition is true, no period has been detected yet. In case the second condition is true, there have been a number of successive positive tests greater than the periodicity “x” to which the counter value of interest Cₓ is associated. In case both conditions are true, the cadence pattern detector CPD carries out step S_{CPD}11 subsequent to step S_{CPD}10. In case the first condition is not true, a period of a relatively great length has already been detected. In case the second condition is not true, there has been an insufficient number of positive tests thus far. In case any of the aforementioned two conditions is not true, the cadence pattern detector CPD carries out step S_{CPD}12 subsequent to step S_{CPD}10.

In step S_{CPD}11, which succeeds step S_{CPD}10 if the aforementioned condition is true, the cadence pattern detector CPD determines that the detected period Pd is equal to the cell index parameter x (Pd=x). This is because there has been a sufficient number of positive tests for the periodicity concerned. The detected period Pd will not be altered when the cadence pattern detector CPD continues carrying out the steps illustrated in FIG. 4. It should be noted that the detected period Pd represents the largest possible periodicity of the input values that are present in the input value register RGI. This is because the cell index parameter x is set to a largest possible value in step S_{CPD}3 or step S_{CPD}4, whichever applies.

In step S_{CPD}12, which may succeed steps S_{CPD}8 or S_{CPD}10, the cadence pattern detector CPD decrements the cell index parameter x by one unit (x:−1). Referring to FIG. 3, this can be regarded as shifting the pointer by one cell position to the left. Subsequently, the cadence pattern detector CPD carries out anew step S_{CPD}6 any following steps, which have been discussed hereinbefore. The series of steps illustrated in FIG. 4 will come to an end if, in step S_{CPD}12, the cell index parameter is decremented from 1 to 0.

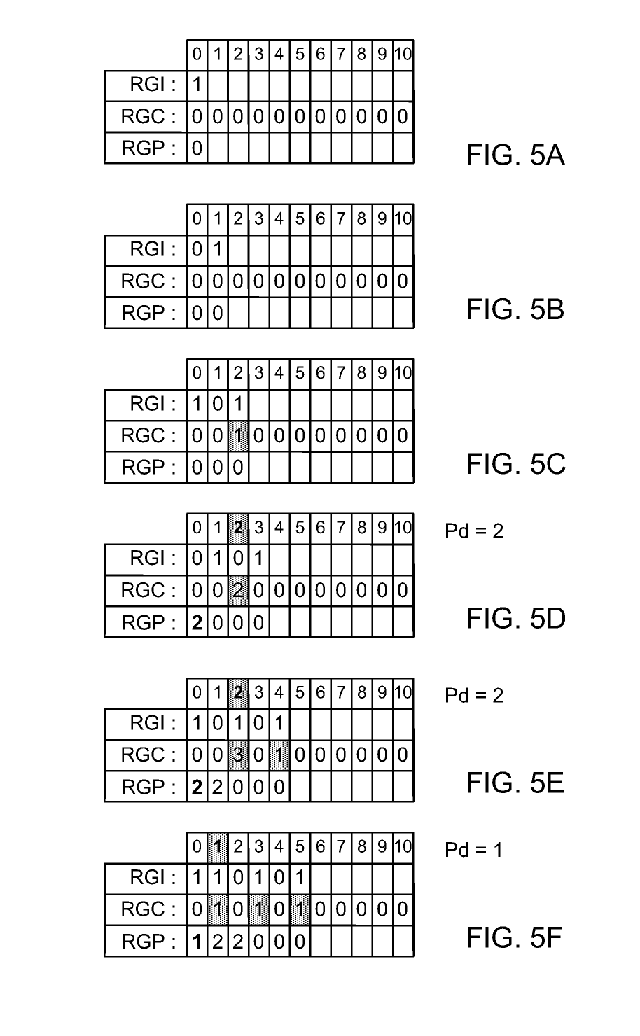

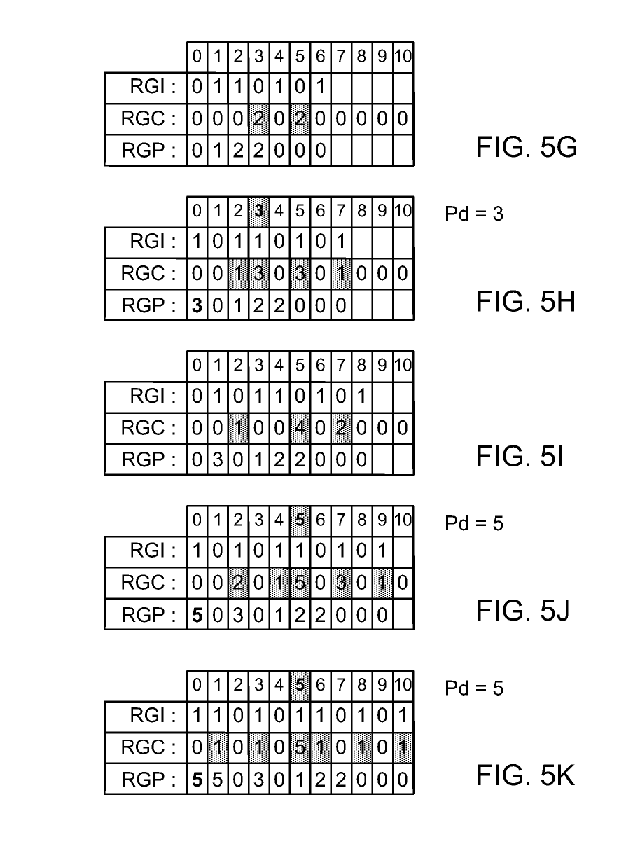

FIGS. 5A-5K illustrate an evolution of register content, as well as detected periods, as a result of the series of steps illustrated in FIG. 4, which the cadence pattern detector CPD carries out. It is assumed that the input value register RGI successively receives the following sequence of classification bits: 101011010110101. There is a basic pattern 10101 with a periodicity of 5. Stated in difference terms, there is a period 10101 of length 5.

Each of the FIGS. 5A-5K is a table with 3 rows and 11 columns, which are numbered from 0 to 10. An upper row represents respective input values in the input value register RGI. A middle row represents respective counter values in the counter value register RGC. A lower row represents respective detected periods in the detected period register RGP. A column number designates a particular cell and therefore a particular value within each of the aforementioned registers. The index of the reference sign of the particular cell and value that are designated corresponds with the column number. For example, column 0 designates input value I₀, counter value C₀, and detected period P₀. Column 1 designates input value I₁, counter value C₁, and detected period P₁.

In FIG. 5A, the input value register RGI has received the first classification bit of the aforementioned sequence, which is equal to 1. In FIG. 5B, the input value register RGI has received the second classification bit, which is equal to 0. Accordingly, in each of the further FIGS. 5C-5K, the input value register RGI has received a subsequent classification bit of the aforementioned sequence. The cadence pattern detector CPD carries out the series of steps illustrated in FIG. 4 when the input value register RGI receives a subsequent classification bit. FIGS. 5A-5K illustrate the effects this has in terms of register content by means of tables in a chronological order. There is a jump from one table to a next table upon reception of a subsequent classification bit.

In each table, the cell index parameter x, which occurs in steps illustrated in FIG. 4, effectively points a particular column. The cell index parameter x points to the column whose number corresponds with the value of the cell index parameter x. In each of the FIGS. 5A-5K, the cell index parameter x initially points to the last column that comprises an input value when going from column 0 to the right on the upper row. The cell index parameter x effectively shifts one column position to the right each time when step S_{CPD}9 is carried out.

In FIGS. 5A-5K, there are counter values that are highlighted by means of gray shading. Such a highlighted counter value has been incremented with respect to the corresponding counter value in the preceding table. Referring to FIG. 4, this means that the condition that is verified in step S_{CPD}7 is true, as a result of which the counter value concerned is incremented in step.

In FIGS. 5A-5K, there are column numbers that appear in bold and that are highlighted by means of gray shading. A column with such a highlighted number comprises a counter value that is greater than the column number concerned or equal thereto. Referring to FIG. 4, this means that the condition that is verified in step S_{CPD}10 is true, as a result of which the column number constitutes the detected period. In this respect, it is noted that the column number corresponds with a current value of the cell index parameter x.

In more detail, FIG. 5A illustrates that the input value register RGI has received the first classification bit, which is equal to 1. The first classification bit is present in cell Ci₀. The counter value register RGC has been reset. All the respective counter values C₀, C₁, C₂, . . . , C_{M} are equal to 0. Since the first classification bit is the only input value that is present in the input value register RGI, the initial value of the cell index parameter x is 0. The cadence pattern detector CPD detects is in step S_{CPD}6 and therefore does not carry out any further step of illustrated in FIG. 4. This is logical because a period cannot be detected on the basis of a single input value.

FIG. 5B illustrates that the input value register RGI has received the second classification bit, which is equal to 0. The second classification bit is present in cell Ci₀ and therefore constitutes input value I₀. The first classification bit has moved to cell Ci₁ and therefore constitutes input value I₁. The cadence pattern detector CPD carries out step S_{CPD}7 only once because the initial value of the cell index parameter x is 1. In step S_{CPD}7, the cadence pattern detector CPD determines that input value I₁ is not equal to input value I₀. As a result, the counter value in column 1 remains zero. No period is detected. The detected period Pd is therefore equal to 0.

FIG. 5C illustrates that the input value register RGI has received the third classification bit, which is equal to 1. The third classification bit is present in cell C₀ and therefore constitutes input value I₀. The first and second classification bits have moved to cells C₁ and C₂, and therefore constitute input values I₁ and I₂, respectively. The initial value of the cell index parameter x is 2. In step S_{CPD}7, the cadence pattern detector CPD determines that input value I₂ is equal to input value I₀. That is, the condition that is verified in step S_{CPD}7 is true. As a result, the counter value in column 2, which was previously 0, is incremented by one unit and is therefore 1.

FIG. 5D illustrates that the input value register RGI has received the fourth classification bit, which is equal to 0. The fourth classification bit constitutes input value I₀. The first, second, and third classification bits now constitute input values I₃, I₂, and I₁, respectively. The initial value of the cell index parameter x is 3, which will be decremented to become 2. In step S_{CPD}7, the cadence pattern detector CPD then determines that input value I₂ is equal to input value I₀. That is, the condition that is verified in step S_{CPD}7 is true. As a result, the counter value in column 2, which was previously 1, is incremented by one unit and is therefore 2. The counter value in column 2 is now equal to the number of this column. In step S_{CPD}10, the cadence pattern detector CPD determines that the two conditions, which are verified in this step, are true. As a result, the detected period Pd is 2.

FIGS. 5E-K illustrate the further evolution of the register content, which results from the cadence pattern detector CPD carrying out the series of steps illustrated in FIG. 4. In FIG. 5E, the input values in columns 2 and 4 are equal to the input value in column 0, which is the fifth detection bit. Consequently, the counter values in columns 2 and 4 are incremented by one unit with respect to the counter values in the previous table illustrated in FIG. 5D. The counter value in column 2, which is 3, is greater than the number of this column. Consequently, the detected period Pd is 2.

In FIG. 5F, the input values in columns 1, 3, and 5 are equal to the input value in column 0, which is the sixth detection bit. Consequently, the counter values in columns 1, 3, and 5 are incremented by one unit with respect to the counter values in the previous table illustrated in FIG. 5E. However, the counter value in column 2, which was 3 in the previous table, is reset because the input value in column 2 is not equal to the input value in column 0. The cadence pattern detector CPD has assessed that the sixth detection bit does not support the previous findings of the periodicity being equal to 2. The counter value in column 1, which is 1, is equal to the number of this column. Consequently, the detected period Pd is 1.

In FIG. 5G, the input values in columns 3 and 5 are equal to the input value in column 1, which is the seventh detection bit. Consequently, the counter values in columns 3 and 5 are incremented by one unit with respect to the counter values in the previous table illustrated in FIG. 5G. However, the counter value in column 1, which was 1 in the previous table, is reset because the input value in column 1 is not equal to the input value in column 0. The cadence pattern detector CPD has assessed that the seventh detection bit does not support the previous findings of the periodicity being equal to 1. No periodicity is detected. The detected period Pd is therefore 0.

In FIG. 5H, the input values in columns 2, 3, 5, and 7 are equal to the input value in column 0, which is the eighth detection bit. Consequently, the counter values in columns 2, 3, 5, and 7 are incremented by one unit with respect to the counter values in the previous table illustrated in FIG. 5G. The counter value in column 3, which is 3, is equal to the number of this column. Consequently, the detected period Pd is 3.

In FIG. 5I, the input values in columns 2, 5, and 7 are equal to the input value in column 1, which is the ninth detection bit. Consequently, the counter values in columns 2, 5, and 7 are incremented by one unit with respect to the counter values in the previous table illustrated in FIG. 5H. However, the counter value in column 3, which was 3 in the previous table, is reset because the input value in column 3 is not equal to the input value in column 0. The cadence pattern detector CPD has assessed that the ninth detection bit does not support the previous findings of the periodicity being equal to 3. No periodicity is detected. The detected period Pd is therefore 0.

In FIG. 5J, the input values in columns 2, 4, 5, 7, and 9 are equal to the input value in column 0, which is the tenth detection bit. Consequently, the counter values in columns 2, 4, 5, 7, and 9 are incremented by one unit with respect to the counter values in the previous table illustrated in FIG. 5I. The counter value in column 5, which is 5, is equal to the number of this column. Consequently, the detected period Pd is 5, which corresponds with the actual periodicity of the sequence of detection bits.

In FIG. 5K, the input values in columns 1, 3, 5, 6, 8, and 10 are equal to the input value in column 0, which is the eleventh detection bit. Consequently, the counter values in columns 1, 3, 5, 6, 8, and 10 are incremented by one unit with respect to the counter values in the previous table illustrated in FIG. 5J. The counter value in column 5, which is 6, is equal to the number of this column. Consequently, the detected period Pd is 5, which corresponds with the actual periodicity of the sequence of detection bits.

The detected period Pd will remain 5 for any subsequently received detection bit from the sequence of detection bits, assuming that the periodicity remains 5.

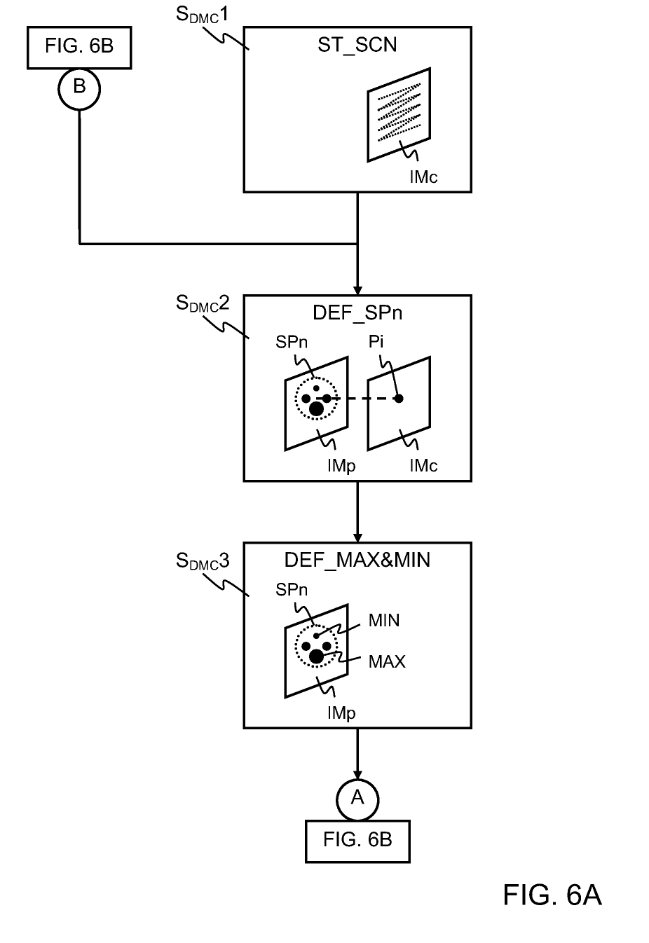

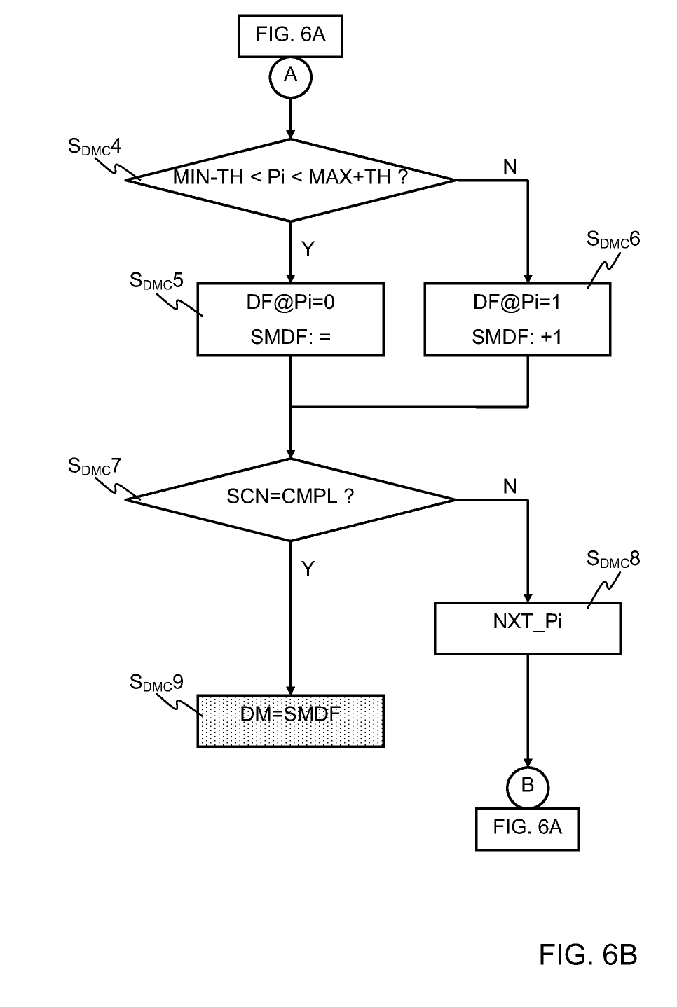

FIGS. 6A and 6B illustrate a series of steps that the difference metric calculator DMC carries out in order to calculate a difference metric DM for a current image IMc in the video input signal VA. Each image in the video input signal VA successively constitutes the current image IMc. The image that constitutes the current image IMc has a neighbor, which is used for calculating the difference metric DM. This neighbor is preferably the most recent image that has been classified as an original image. This image IMp will be referred to as previous image hereinafter.

In step S_{DMC}1, the difference metric calculator DMC starts a scan of the current image IMc in accordance with a given pattern (ST_SCN). The difference metric calculator DMC successively designates pixels while scanning the current image IMc. Each designated pixel has a particular spatial position within the current image IMc. The difference metric calculator DMC repetitively carries out steps S_{DMC}2-S_{DMC}7 for each designated pixel until the scan is completed. In doing so, the difference metric calculator DMC successively updates a sum of local differences SMDF, which will be explained in greater detail hereinafter. The sum of local differences SMDF is given the value 0 before the difference metric calculator DMC starts the scan, which involves successively carrying out steps S_{DMC}2-S_{DMC}7.

In step S_{DMC}2, the difference metric calculator DMC defines a set of neighboring pixels SPn in the previous image Imp (DEF_SPn). The pixels of this set have respective positions in the previous image IMp that are relatively similar to the position of the designated pixel in the current image IMc. For example, the difference metric calculator DMC may define a particular area that comprises the position of the designated pixel. This area can be projected on the previous image IMp. Pixels in the previous image IMp that fall into this projected area constitute the set of neighboring pixels SPn.

In step S_{DMC}3, the difference metric calculator DMC determines a maximum value MAX and a minimum value MIN within the set of neighboring pixels SPn in the previous image IMp (DEF_MAX&MIN). In the set of neighboring pixels SPn, there will be two extremes in terms of pixel values: a pixel with a highest value and a pixel with a lowest value. The maximum value MAX corresponds with the highest pixel value within the set of neighboring pixels SPn. The minimum value MIN corresponds with the lowest pixel value.

In step S_{DMC}4, the difference metric calculator DMC determines whether the following condition is true or not: the designated pixel has a value that is comprised between the minimum value MIN minus a threshold TH and the maximum value MAX plus the threshold TH (MIN−TH<Pi<MAX+TH ?). In case the aforementioned condition is true, it can be said that there is relatively little difference between the current image IMc and the previous image IMp at the position of interest. In that case, the difference metric calculator DMC carries out step S_{DMC}5. In case the aforementioned condition is false, it can be said that there is a significant difference between the current image IMc and the previous image IMp at the position of interest. In that case, the difference metric calculator DMC carries out step S_{DMC}6.

It should be noted that the threshold TH, which is applied in step S_{DMC}5, may be fixed or variable. In the latter case, the threshold TH may depend on, for example, local spatial activity in the vicinity of the position concerned. The threshold TH may be relatively low if the current image IMc and the previous image IMp are relatively smooth in the vicinity of the position concerned. Conversely, the threshold TH may be relatively high if there are relatively many details in the vicinity of the position concerned. It should also be noted that the threshold TH may be asymmetric in the sense that different thresholds are associated with the minimum value MIN and the maximum value MAX.

In step S_{DMC}5, the difference metric calculator DMC determines that the local difference for the designated pixel is equal to 0 (DF@Pi=0). The sum of local differences SMDF has a given value, which is maintained in step S_{DMC}5 (SMDF: =). That is, the sum of local differences SMDF has the same value before and after step S_{DMC}5.

In step S_{DMC}6, the difference metric calculator DMC determines that the local difference for the designated pixel is equal to 1 (DF@Pi=1). The sum of local differences SMDF is incremented by one unit (SMDF: +1). That is, a sum of local differences SMDF will be one unit higher after step S_{DMC}6.

In step S_{DMC}7, the difference metric calculator DMC verifies whether the scan is complete or not (SCN=CMPL?). In case the scan is not complete, the difference metric calculator DMC designates a subsequent pixel by moving one position in the pattern of the scan. This is done in step S_{DMC}8 (NXT_Pi), which is followed by steps S_{DMC}2-S_{DMC}7 that are carried out for the subsequent designated pixel. In case the scan is complete, the difference metric calculator DMC determines that the difference metric DM for the current image IMc is equal to the sum of local differences SMDF and the end of the scan. This is done in step S_{DMC}9 (DM=SMDF). The difference metric calculator DMC applies the difference metric DM, which has been established by carrying out the series of steps illustrated in FIGS. 6A and 6B, to the classification bit generator CBG illustrated in FIG. 3.

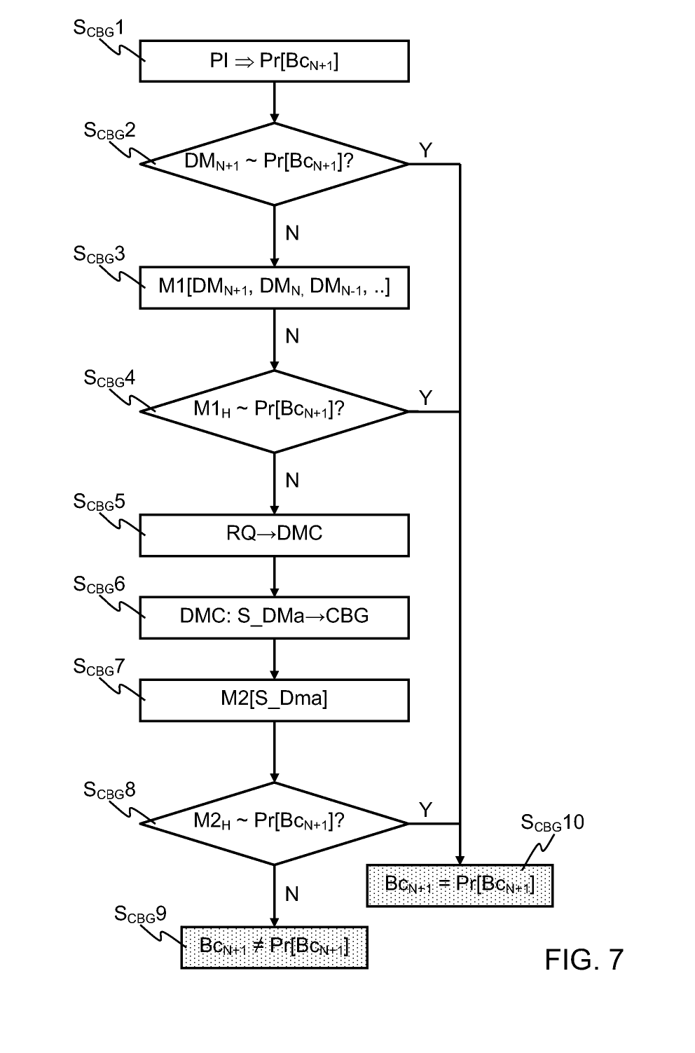

FIG. 7 illustrates a series of steps S_{CBG}1-S_{CBG}10 that the classification bit generator CBG carries out in order to determine a classification bit BC_{N+1} for a frame of interest whose number is N+1. The difference metric calculator DMC has produced a difference metric DM_{N+1} for the frame of interest, as well as further difference metrics DM_{N}, DM_{N-1}, . . . for previous frames. As explained hereinbefore with reference to FIG. 3, the classification bit generator CBG utilizes the pattern indication PI that the cadence pattern detector CPD provides.

In step S_{CBG}1, the classification bit generator CBG determines an expected classification bit Pr[BC_{N+1}] for the frame of interest on the basis of the pattern indication PI (PI [symbol] Pr[Bc_{N+1}]). That is, the classification bit generator CBG effectively predicts on the basis of the pattern indication PI whether the frame of interest will be classified as an original frame or a repeat frame.

In step S_{CBG}2, the classification bit generator CBG determines whether the difference metric DM_{N+L} for the frame of interest is in conformity with the expected classification bit Pr[BC_{N+1}], or not (DM_{N+1}˜Pr[Bc_{N+1}]?). For example, the difference metric DM_{N+1} should have a relatively low value if the expected classification bit Pr[BC_{N+1}] classifies as the frame of interest as a repeat frame. Conversely, the difference metric DM_{N+1} should have a relatively high value if the expected classification bit Pr[BC_{N+1}] classifies as the frame of interest as an original frame. In case the difference metric DM_{N+1} is in conformity with the expected classification bit Pr[BC_{N+1}], the classification bit BC_{N+1} is equal to the expected classification bit Pr[BC_{N+1}]. Step S_{CBG}10 symbolizes this conclusion (BC_{N+1}=Pr[Bc_{N+1}]). Conversely, in case the difference metric DM_{N+L} is not in conformity with the expected classification bit Pr[BC_{N+1}], the classification bit generator CBG continues and carries out steps S_{CBG}3 and S_{CBG}4.

In step S_{CBG}3, the classification bit generator CBG calculates a measure of probability M1 for a sequence of classification bits to correspond with a sequence of difference metrics that the difference metric calculator DMC has produced (M1[DM_{N+1}, DM_{N}, DM_{N-1}, . . . ]). The measure of probability M1 can be seen as a degree of match between the sequence of classification bits concerned and the sequence of difference metrics. The classification bit generator CBG calculates several of such measures M1 for various sequences of classification bits. A particular sequence of classification bits will have the highest measure of probability M1_{H}. This particular sequence provides a prediction of the classification bit BC_{N+1} for the frame of interest.

In step S_{CBG}4, the classification bit generator CBG determines whether the sequence of classification bits that has the highest measure of probability M1_{H} is in conformity with expected classification bit Pr[BC_{N+1}], or not (M1_{H} ˜Pr[Bc_{N+1}]?). That is, the classification bit generator CBG determines whether the prediction on the basis of the sequence of difference metrics corresponds with the expected classification bit Pr[BC_{N+1}] on the basis of the pattern indication PI, or not. In case the sequence of classification bits that has the highest measure of probability M1_{H} in conformity with the expected classification bit Pr[BC_{N+1}], the classification bit is equal to the expected classification bit Pr[BC_{N+1}]. Step S_{CBG}10 symbolizes this conclusion (BC_{N+1}=Pr[Bc_{N+1}]). In the opposite case, which means there is no conformity, the classification bit generator CBG continues and carries out steps S_{CBG}5-S_{CBG}8.

In step S_{CBG}5, the classification bit generator CBG requests the difference metric calculator DMC to calculate additional difference metrics (RQ→DMC). An additional difference metric DM_{N+1} may be calculated as illustrated in FIGS. 6A and 6B described hereinbefore. However, a different image will constitute the previous image. For example, the previous image may be the last but one most recent image that has been classified as being an original image.

In step S_{CBG}6, the difference metric calculator DMC provides a set of additional difference metrics S_DMa in response to the request that the classification bit generator CBG has made (DMC: S_DMa→CBG).

In step S_{CBG}7, the classification bit generator CBG calculates a new measure of probability M2 for a sequence of classification bits on the basis of the additional difference metrics, which have become available (M2[S_Dma]). The classification bit generator CBG calculates several of such new measures M2 for various sequences of classification bits. A particular sequence of classification bits will have the highest new measure of probability M2_{H}. This particular sequence provides a new prediction of the classification bit for the frame of interest.

In step S_{CBG}8, the classification bit generator CBG determines whether the sequence of classification bits that has the highest new measure of probability M2_{H} is in conformity with expected classification bit Pr[BC_{N+1}], or not (M2_{H}˜Pr[Bc_{N+1}]?). That is, the classification bit generator CBG determines whether the new prediction, which takes into account the additional difference metrics, corresponds with the expected classification bit Pr[BC_{N+1}] on the basis of the pattern indication PI, or not. In case the sequence of classification bits that has the highest new measure of probability M2_{H} in conformity with the expected classification bit Pr[BC_{N+1}], the classification bit is equal to the expected classification bit Pr[BC_{N+1}] Step S_{CBG}10 symbolizes this conclusion (BC_{N+1}=Pr[Bc_{N+1}]). In the opposite case, which means there is no conformity, the classification bit generator CBG finally concludes that the classification bit is unequal to the expected classification bit Pr[BC_{N+1}]. Step S_{CBG}9 symbolizes this conclusion (BC_{N+L} ≠Pr[Bc_{N+1}]), which implies the pattern indication PI will no longer apply. The pattern has been broken, which may be due to, for example, a scene change.

It should be noted that any of the functional entities illustrated in FIG. 3 may be implemented by means of software or hardware, or a combination of software and hardware. For example, each of these functional entities may be implemented by suitably programming a processor. In such a software-based implementation, a software module may cause the processor to carry out specific operations that belong to a particular functional entity. As another example, each of the aforementioned functional entities may be implemented in the form of a dedicated circuit. This is a hardware-based implementation. Hybrid implementations may involve software modules as well as one or more dedicated circuits.

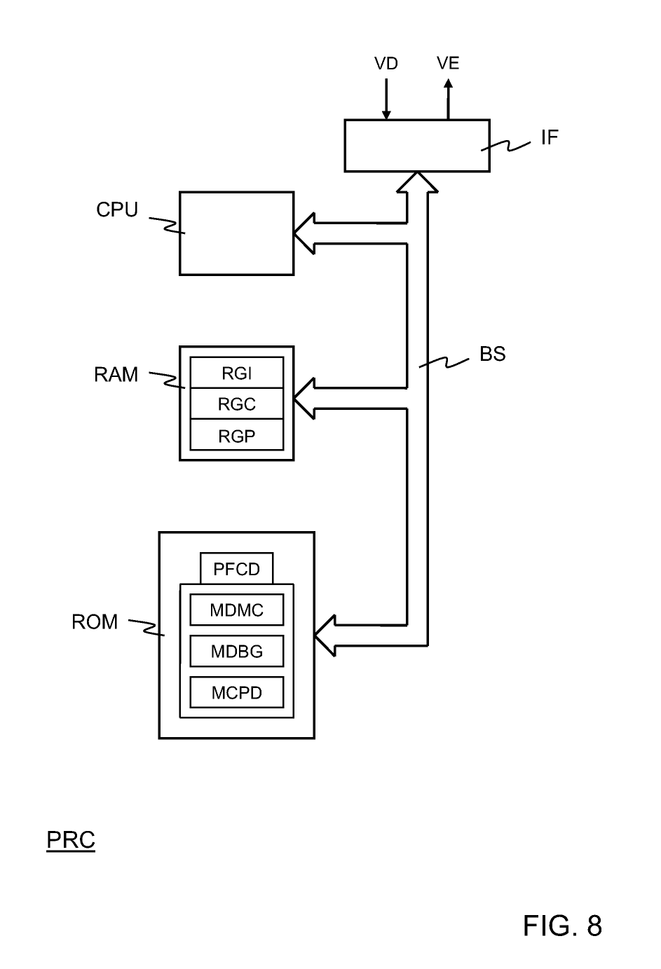

FIG. 8 illustrates a processor PRC that is a software-based implementation of the film cadence detector FCD illustrated in FIG. 3. The processor PRC comprises an interface IF, an instruction-executing circuit CPU, a volatile memory RAM, and a nonvolatile memory ROM. A bus BS couples the aforementioned elements to each other. The processor PRC receives the video input signal VA via the interface IF and provides the pattern indication PI via the interface IF. To that end, the interface IF may comprise one or more data buffers.

The volatile memory RAM comprises the input value register RGI, the counter value register RGC, and the detected period Pd register illustrated in FIG. 3. The nonvolatile memory ROM comprises a film cadence detection program PFCD. The film cadence detection program PFCD comprises a set of instructions, which causes the instruction-executing circuit CPU to carry out various operations that have been described with reference to the film cadence detector FCD illustrated in FIG. 3. The film cadence detection program PFCD may comprise various modules MDCM, MCBG, MCPD, each of which implements a particular functional entity illustrated in FIG. 3.

The processor PRC illustrated in FIG. 8 may be, for example, a personal computer, a personal communication device, or any other type of apparatus that has data processing capabilities. The nonvolatile memory ROM may be in form of, for example, a hard disk, an electrically erasable programmable read-only memory, or any other type of medium that is capable of storing data. The film cadence detection program PFCD may be written into the nonvolatile memory ROM by downloading this program from a server via a communication network, which may comprise the Internet. Such a download may be subject to a payment. In an alternative, the film cadence detection program PFCD and the training software program may also be downloaded into the volatile memory RAM when a video enhancement function is required at a particular instant. The film cadence detection program PFCD needs to be downloaded anew when the apparatus has been switched off.

### CONCLUDING REMARKS

The detailed description hereinbefore with reference to the drawings is merely an illustration of the invention and the additional features, which are defined in the claims. The invention can be implemented in numerous different manners. In order to illustrate this, some alternatives are briefly indicated.

The invention may be applied to advantage in any type of product or method that can be arranged to process a video signal, which has a pull-down pattern. The video system VSY illustrated in FIG. 1 is merely an example. The invention may equally be applied to advantage in, for example, a communication apparatus that is capable of receiving image via a network, such as, for example, the Internet. The communication apparatus may be in the form of, for example, a personal computer, a set-top box, a cellular phone, or a personal digital assistant.

Film cadence detection in accordance with the invention may be used for numerous different applications. For example, the film cadence detection may be used for a so-called pull-down optimization. FIG. 2 illustrates that the pattern indication PI allows reconstructing the original motion picture VO. An output video signal of relatively high frame rate can be generated on the basis of the original motion picture VO by repeating original frames in a manner similar to that used in the telecine process. This output video signal can be given an optimal pull-down pattern in the following manner. Each frame in the output video signal has a given position on the time axis. Each original frame also has a given position on the time axis. Each frame in the output video signal is a copy of the original frame that is closest to that frame in the output video signal. Accordingly, the output video signal will have minimal judder.

A film cadence detector in accordance with the invention may comprise further functional entities, which are not illustrated in FIG. 3. For example, a film cadence detector may comprise a scene change detector. The scene change detector may detect a scene change for a given frame, if the given frame is classified as an original frame and if the given frame differs to a relatively great extent from a previous original frame. The film cadence detector may further comprise a so-called hybrid detector, which detects whether there are any overlays in a video input signal. For example, a subtitle or a logo constitute such an overlay, which may be present in the video input signal. This hybrid detection can be done on a periodic basis in case the film cadence detector detects a particular pull-down pattern.

There are numerous different manners to implement a film cadence detector in accordance with the invention. FIGS. 3-7 illustrate specific implementations for which there are many variants. For example, a film cadence detector in accordance with the invention need not necessarily comprise a counter value register. A cadence patent detector may verify whether the relevant condition for detecting a periodicity is true or false by scanning through a sequence of classification bits. With regard to the implementation illustrated in FIG. 3, it should be noted that the cadence pattern detector CPD may conveniently update the counter value register RGC and provide detected periods Pd by carrying out a series of steps different from those illustrated in FIG. 4. For example, the cadence pattern detector CPD may first update the respective counter values in a particular phase. A subsequent phase starts when all the counter values have been updated. In this subsequent phase, the cadence pattern detector CPD checks counter values to see if a counter value is equal to or greater than the natural number, which represent a period length, with which the counter value is associated.

There numerous different manners to calculate a difference metric for an image, which represents a degree of similarity between that image and another image. FIGS. 6A and 6B illustrates a specific example in which local differences for particular pixels are calculated. Moreover, these local differences are expressed in the form of binary values. In different embodiments, local differences may relate to areas in both images, which are effectively compared. Local differences may be expressed in the form of digital values.

The terms “image” and “frame” should be understood in a broad sense. These terms includes a frame, a field, and any other entity that may wholly or partially constitute an image or a picture.

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description with reference to the drawings, illustrate rather than limit the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A method of detecting a film cadence in a video signal (VA), the method comprising:
a classification indication generation step in which successive classification indications (BC_{N}, BC_{N-1}, BC_{N-2}, . . . ) are generated for successive images within the video signal, a classification indication belonging to a particular image and classifying that particular image as an original image or a repeat image; and
a cadence pattern detection step in which a condition is checked for at least X successive classification indications, X representing a natural number in a given range, the condition being that each one of the at least X successive classification indications is equal to the X-th previous classification indication and, if the condition is true, providing a pattern indication (PI) that corresponds with the natural number that X represents and, if the condition is false, checking the condition anew with X representing another natural number in the given range.

2. A method of detecting a film cadence according to claim 1 whereby, in the cadence pattern detection step, the condition is first checked with X representing the highest natural number in the range and whereby, if the condition is false, the condition is checked anew with X representing a next highest natural number.

3. A method of detecting a film cadence according to claim 1, the method involving a counter register (RGC) comprising respective counter values (C₀, C₁, C₂, . . . , C_{M}), a counter value being associated with a particular natural number that X may represent, the method comprising the following steps, which are executed when a new classification indication is generated:
a counter register update step (S_{CPD}7) in which for each natural number that X may represent it is checked whether the new classification indication is equal to the X-th previous classification indication and, if so, incrementing the counter value that is associated with the natural number that X represents, and, if not, resetting the counter value that is associated with the natural number that X represents; and
a counter register monitoring step (S_{CPD}10) in which it is checked whether a counter value is at least equal to the natural number with which the counter value is associated and, if so, providing a pattern indication (PI) that corresponds with this natural number.

4. A method of detecting a film cadence according to claim 1, the method comprising:
a local difference determining step in which a series of substeps are carried out for various pixels in a current image (IMc), each of these pixels (Pi) having a particular value and a particular position within the current image, the series of substeps comprising:
a neighboring pixel set definition substep (S_{DMC}2) in which a set of neighboring pixels (SPn) in a neighboring image (Imp) is defined, the neighboring pixels having respective positions within the neighboring image, which are similar to the position of the pixel in the current image;
a minimum and maximum determining substep (S_{DMC}3) in which a minimum pixel value (MIN) and a maximum pixel value (MAX) within the set of neighboring pixels is determined;
a comparison substep (S_{DMC}4) in which a local difference (DF@PI) for the pixel is determined, the local difference having a first given value (0) or a second given value (1) depending on whether the value of the pixel is within a range that depends on the minimum pixel value and the maximum pixel value or outside this range, respectively;
a summing step in which a sum (SMDF) of the respective local differences for the respective pixels is calculated, the sum representing a difference metric (DM) for the current image a classification step in which the current image is classified as an original image or a repeat image on the basis of at least the difference metric for the current image.

5. A method of detecting a film cadence according to claim 1, the method comprising:
a difference metric calculation step in which successive difference metrics (DM) are calculated for successive images in the video signal (VA), a difference metric relating to a particular image and indicating a degree of difference between that image and a neighboring image;
a classification step in which a current image is classified as an original image or a repeat image on the basis of at least the difference metric (DM) for the current image and the pattern indication (PI), which the cadence pattern detection step provides.

6. A method of detecting a film cadence according to claim 5, the method comprising:
a prediction step (S_{CBG}1) in which an expected classification indication Pr(Bc_{N+1}) is determined for the current image on the basis of the pattern indication (PI);
a statistical analysis step (S_{CBG}7) in which a most probable sequence of classification indications (M2_{H}) is determined on the basis of several difference metrics;
a verification step (S_{CBG}8) in which it is verified whether the most probable sequence of classification indications is in conformity with the expected classification indication, or not; and
an output step in which the classification indication for the current image is made equal to the expected classification indication if the verification step is positive and in which the classification indication for the current image is made unequal to the expected classification indication if the verification step is negative.

7. A film cadence detector (FCD), comprising:
a classification indication generator (DMC, CBG) arranged to generate successive classification indications (BC_{N}, BC_{N-1}, BC_{N-2}, . . . ) for successive images within a video signal (VA), a classification indication belonging to a particular image and indicating whether that particular image is an original image or a repeat image; and
a cadence pattern detector (CPD) arranged to check a condition for at least X successive classification indications, X representing a natural number in a given range, the condition being that each one of the at least X successive classification indications is equal to the X-th previous classification indication, the cadence pattern detector being further arranged to provide a pattern indication (PI) if the condition is true, the pattern indication corresponding with the natural number that X represents and, if the condition is false, to check the condition anew with X representing another natural number in the given range.

8. A video system (VSY) comprising a film cadence detector (FCD) according to claim 7 and a video processor (FRC) arranged to process the video signal in dependence on the pattern indication (PI) that the film cadence detector provides.

9. A computer program product for a programmable processor (PRC), the computer program product comprising a set of instructions (PFCD) that, when loaded into the programmable processor, causes the programmable processor to carry out the method according to claim 1.
